(19) United States
(12) Patent Application Publication
(10) Pub. No.: US 2009/0255927 A1
(43) Pub. Date: Oct. 15, 2009

(54) Bin and Tank Assembly

(76) Inventor: Anthony Earl Flecknoe-Brown, Yarra Glen (AU)

Correspondence Address: Anthony Flecknoe-Brown, 370 Yarraview Road, Yarra Glen, Victoria, 3775, AU

(21) Appl. No.: 12/420,069

(22) Filed: Apr. 8, 2009

(30) Foreign Application Priority Data
Apr. 10, 2008 (AU) 2008901728

(51) Int. Cl. B65D 6/00; B65D 21/032; C12C 11/00

(52) U.S. Cl. 220/4.13; 220/661; 220/495.03; 206/386; 206/503; 220/378; 220/694; 426/11

(57) ABSTRACT

A container assembly for controlling rate of oxygen transfer from the atmosphere into a liquid stored in the container assembly comprising,
a fork-liftable pallet bin (1) with solid or erectable sides,
a sealable, polyethylene container (2) which allows oxygen to enter at a rate between 5 milligrams mg/l/yr and 75 mg/l/yr, having a self-supporting shape that substantially conforms to the internal surface dimensions of the bin, and
a closure (3) for the neck of the container with a recessed top face (5) and a protruding, sealable outlet (20) to allow filling to a level above the recessed top face.

### FIELD OF THE INVENTION

This invention relates to the control of oxygenation of stored liquids. It relates particularly but not exclusively to methods and apparatus for the control of oxygenation of wine and spirits. More particularly it relates to the oxygen-driven maturation of dry table wine. A ‘dry table wine’ is a red, white or rose wine that is fermented to ‘dry’, i.e. contains little if any residual sugar and/or has no sugars or ethanol added. Dry table wines do not include:
Sparkling wines such as Champagne, which have added sugar to promote a second fermentation which generates dissolved CO2, or that have CO2 added under pressure
Fortified wines such as port wine, which have ethanol added to stop the ferment before all the fruit sugar is consumed
Sherry wines, which are surface-air-contact matured after fermentation to develop prominent acetaldehyde character.

### BACKGROUND OF THE INVENTION

Co-pending applications, published as WO 2005/052114 and WO2007/068052 (both herein incorporated by reference), describe container assemblies for controlling the rate of oxygen transfer from the atmosphere into a liquid stored in the container comprising:
A container with an oxygen permeability of 50 ml to 300 ml of oxygen per atmosphere of oxygen pressure, per square metre of area of wall surface area, for each 1 mm of thickness of said wall, per 24 hour period at room temperature which is self-supporting when empty, thus able to keep its shape, optionally fitted into a frame to prevent bulging of a side wall when full
A container for the maturation of dry table wine of any size, made of polyethylene which allows oxygen to enter the stored wine at a rate between 5 milligrams per litre of wine stored, per year (mg/l/yr) and 75 mg/l/yr
A support frame which also enables access underneath (or in any other location) for the tynes of a forklift and to provide a means to stack the containers vertically
A container with an open neck extending from an upper wall of the container with the upper wall being shaped so as to allow substantially all air to flow out during filling
An outlet for draining liquid from the bottom of the container arranged near a bottom wall
An optional floating barrier member for providing a barrier to limit oxygen access from the head space in the container to the surface of the liquid

Whilst the container assemblies described in those two prior applications are effective for many requirements, there is a range of additional requirements which need to be met by developing those inventions further.

These include:
constructing as many of the components of the assembly as possible from moulded plastic polymer materials
utilizing common, low cost, mass produced components where possible
providing a non-corrodible assembly
providing structural support means to allow vertical stacking of two or more filled assemblies, one upon the other
providing an additional outlet for sampling of contents, protected from accidental damage
providing a closure method which allows substantially all of the head space and any free surface to be removed when the vessel is full
providing protection to minimize the possibility of accidental damage to the container, valves or other components of the assembly
providing a secure stacking means to allow two stacked filled tanks to be safely transported by road
providing a container with an interior which is smooth, uninterrupted, recess-free, self draining, hygienic and easy to clean
providing easy disassembly and access for cleaning
providing a shape and size to fit compactly within a standard (i.e. ISO) six meter shipping container, for example on a two-wide by two-high basis, whilst optionally maintaining the correct relationship between the internal liquid contact surface area, the material thickness and the volume to maintain the desired rate of oxygenation of the contents, i.e. to have plan dimensions equivalent to standard goods pallets.

Accordingly the following is a description of an invention which facilitates all of these improvements

### DISCLOSURE OF THE INVENTION

The invention provides for a container assembly for controlling the rate of oxygen transfer from the atmosphere into a liquid stored in the container assembly comprising:
a typical single piece moulded polymer pallet bin or a fabricated or assembled polymer, wood or metal based pallet, crate or tote bin, straight or taper-sided, optionally made up of a number of pieces, with fixed, detachable or erectable side walls. Such pallets, crates or bins (hereinafter referred to as ‘pallet bins’), optionally include strengthening, stiffening and locating means that enable two or more such identical bins to be safely stacked vertically and optionally to be transported two-high when filled.
a moulded polyethylene, self-supporting, closable container which allows oxygen to enter stored wine or other oxygen demanding liquid contents at a rate between 5 milligrams per litre of liquid stored per year (mg/l/yr) and 75 mg/l/yr and having a shape that substantially conforms to the internal surface dimensions of and fits into the aforesaid pallet bin, having:
a sealable closure or lid for the neck of the closable container with a recessed top face which enables the liquid level in the filled container to be lowered when the lid is removed
a protruding outlet located on the recessed face or on the top rim of the closure extending above the height of the recessed face and preferably above the height of the lid rim, providing an exit for head space air trapped under the recessed face or in the rim of the lid. That outlet is further fitted with a stopper or bung.
an optional bottom outlet for draining liquid from the container assembly arranged on or near a bottom wall of the assembly. The outlet may comprise a screw plug or a valve
an optional further outlet for the purpose of drawing a sample of liquid from the container assembly. This outlet may comprise a screw plug or a valve

The bottom outlet may be fitted within a recess in the pallet bin, so that it is protected when the container assembly is being transported.

The optional second outlet may be fitted within a recess in the pallet bin, so that it is protected when the container assembly is being transported.

The removable closure or lid used to close and seal the closable container neck may be attached by clamp, screw thread or any other closure retaining means.

That lid may be large enough for a person to pass through.

That lid may include a ring seal or gasket which can engage between the lid and the top rim of the container to make a hermetic seal.

That seal ring or gasket may be loose or shaped so as to be retained on the rim of the neck or within the lid.

A smaller outlet may be provided on the lid which can also be closed and sealed such as by a compliant bung or a screw-plug.

The pallet bin component of the container assembly may be provided with recesses for the entry of the tynes of a forklift from two or four sides.

The tyne recesses may optionally contain bars or other retaining means to restrain the container assembly when tipped over by a forklift fitted with a rotating head.

The container assembly may include a plurality of oak staves disposed in the interior of the container in contact with the liquid.

### DESCRIPTION OF PREFERRED EMBODIMENT

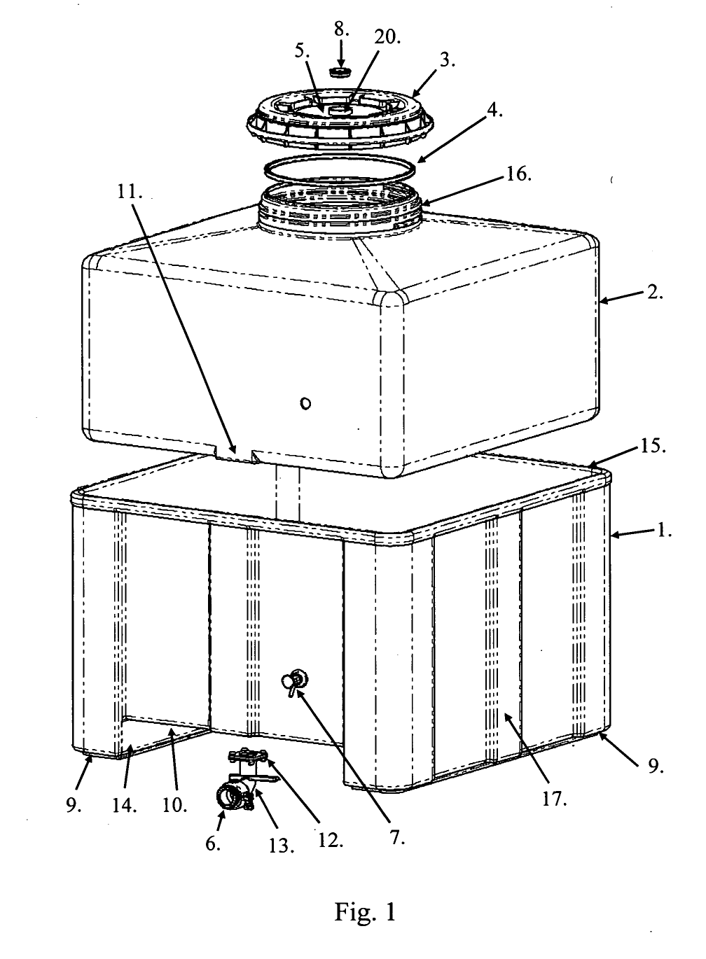

FIG. 1. shows an exploded view of one embodiment of the container assembly with a molded polymer pallet bin, inner container, lid and various other components shown separated.

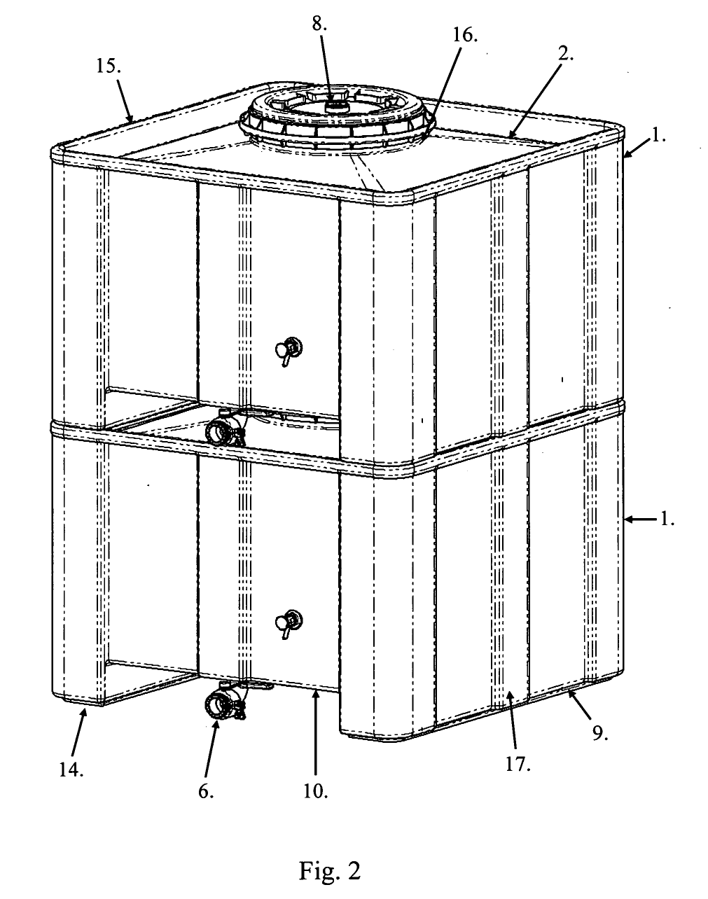

FIG. 2. shows two container assemblies stacked vertically one upon the other.

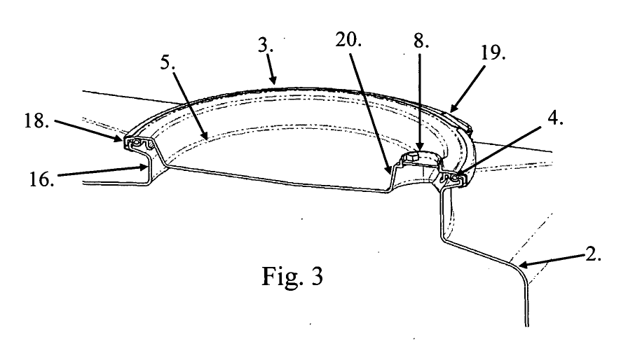

FIG. 3. is a cross section view showing another embodiment of a container fitted with a clamp lid.

### INTEGER LIST

1 Pallet bin
2 Container
3 Closure lid
4 Seal ring
5 Recessed face
6 Outlet valve
7 Sample tap
8 Plug
9 Stacking step
10 Recess
11 Sump
12 Bolted connection
13 Elbow
14 Foot
15 Top rim
16 Neck
17 Vertical stiffener
18 Clamp ring
19 Toggle clamp
20 Protruding outlet

One embodiment of the apparatus of our invention is illustrated in FIG. 1 and FIG. 2 herein. FIG. 1 shows a pallet bin (1) into which can be fitted an inner closed container (2) having a neck (16) forming part of the top wall of the container. The neck can be closed and sealed by a closure lid (3). The bin (1) shown is a typical single piece moulded polymer pallet bin but may also be a fabricated or assembled multi-piece open top box, crate or tote bin made from polymer, wood or metal or any combination thereof. The bin may optionally be straight or taper-sided and optionally may have fixed, detachable or erectable side walls which may be hinged or otherwise fastened together in any way that resists the bulging forces of the full container within.

The plan view shape of the pallet bin (1) is generally preferred to be square or rectangular for closest packing of one bin to the other sidewise and lengthwise, but may also be trapezoidal, cylindrical, elliptical or of any other shape. If rectangular, it is preferred that the dimensions of the rectangle be the same as, or a unit multiple or fraction of the standard size of an Australian transport pallet (1160×1160 mm), of an ISO pallet (1200 mm×1000 mm) or of a US pallet of up to 48 inches square.

The side walls of the bin (1) may be vertical, may taper outwards or inwards or may be curved in the vertical or horizontal direction. Preferably each side wall will contain at least one vertical stiffening or strengthening rib (17) which may be a single thickness rib within the bin wall, or double walled ribs that leave the bin inside surface smooth whilst providing a projecting rib on the outside surface, or beams or frames forming part of or attached to the outside of the bin walls.

The bin may be provided with a recess (10) for the entry of forklift tynes for lifting and tipping the container.

Retaining rods (not shown) may penetrate and be retained within the pallet bin feet (14), enabling the container assembly to be retained on fork-lift tynes when rotated to any angle. There are many alternative ways to achieve such retention, including but not limited to moulded-in cross members, loops bolted within the recesses (10) and bars bolted onto the underside of the bin feet across those recesses.

It is to be noted that the shape and dimensions of the inner container (2) are generally to match with the internal shape and dimensions of the pallet bin (1) into which the container fits

The inner container (2) of this embodiment has generally flat side walls that extend down to a flat bottom wall and is preferably sized to be a close fit within the bin, so that the bin walls brace and support the container walls when filled with liquid. In this embodiment a small sump (11) is provided with a hole for discharge of the contents at the lowest point via a bottom outlet valve (6) that is normally bolted onto the floor of the sump by means of a bolted connection (12). Thus the contents of the inner container will normally fully drain through the floor of the sump.

The outlet valve (6) is preferably located within the recess in the base of the bin (10) so that it is protected from damage by accident or abuse when the container assembly is moved about.

In this embodiment a flanged elbow (13) may be held in place by bolted connections (12) which may screw into or onto thread inserts which have been moulded into the floor of the container (not shown). The base of the bin may be provided with a hole (not shown) to clear the bolted connection (12) which is fitted to the floor of the sump (11) of the inner container.

Many types of valve outlets and connections may be used, including clamped or welded bulkhead fittings, moulded-in metal or non-metallic threaded sockets or nipples and threads cut or moulded directly into or onto a spigot or projection.

Many different outlet valve locations are also possible, such as through the container bottom walls along one edge, in a corner or in the centre of the container bottom wall, or though any side wall near to the bottom wall and with or without a sump.

A convenient recess in a side wall of the bin, such as may be formed between two projecting stiffening ribs (17) or similarly projecting corners, may accommodate a sample outlet with an optional valve or tap (7). Fitting such within such a recess may protect it from damage when the container assembly is transported. By connecting the sampling valve though a matching hole in the inner container, a sample of the contents of the container may be conveniently removed. Such a valve or tap is also one convenient way to introduce a sparge gas should the contents be a liquid.

Some or all of any between-wall cavities in the pallet bin may be filled with rigid or flexible solid or foam filler to add to the structural rigidity or insulation value.

In regard to the shape of the top wall of the container (2), it is to be noted that it generally rises up to the outlet neck (16) such that as the container is filled, any air under the top wall flows towards and out of the outlet neck.

In this embodiment the outlet neck (16) incorporates a moulded thread to which a screw lid (3) may be engaged and retained. A seal ring (4) in the form of a U-section profile is fitted to the top of the neck (16) above the thread and forms a seal by engaging with the underside of the lid (3). Seal rings will generally be made from food-contact approved and compliant materials such as elastomeric, sponge or deformable polymeric materials or they may constructed from normally stiff materials made compliant by geometry.

The lid of this embodiment has a recess (5) in its top face. A protruding outlet (20), sealed with a plug (8) is fitted into that recessed face. During filling the liquid level is preferred to fill into the riser. When filled into the riser, the free surface of the liquid contacts the underside face of the lid recess and the liquid surface area exposed within the neck is thus reduced proportionally by the extent to which the recessed part of the lid occupies the neck opening inside of the seal ring (4).

The lid plug (8) may be removed at will for adding or removing some of the contents or to vent off ferment gas by fitting a one way valve (not shown) in its place.

The outlet (20) and plug (8) may be located anywhere within the area of the lid recess, or on the topmost outer ring portion of the lid. In this instance the outlet and its associated riser is located in the centre of the lid recess. The plug may be a compliant bung, a screw threaded male plug or female cap, a clamped-on closure or any other means to close and hermetically seal the outlet.

There are many ways in which the lid (2) may be retained and clamped to ensure a leak-free connection when the tank is full. Such alternatives include elastomeric or metal spring type hold-downs, toggle clamps, screw connectors, weights, clamp rings or bolted frames.

FIG. 3. is a cross section view showing another embodiment of a container (2) fitted with a clamp lid (3) secured by means of a clamp ring (18) locked by a toggle clamp (19). In this instance the seal ring (4) is circular in cross section and sits loosely within a recess in the neck flange. The lid has a recessed centre (5) leading to a riser (20), which allows substantially all air to vent out of the closable plug (8). When filled up into the riser (20) just under the lid plug (8), there is substantially no head space air or free liquid surface. Such free surfaces are generally undesirable for perishable liquid foods such as wine, due to surface microbial activity.

The lid (3) is preferably large enough to allow full man-access to the interior of the container to enable it to be properly cleaned.

In FIG. 2, the container assembly is shown stacked vertically upon a substantially identical lower container assembly. Each outer bin (1) has a top rim (15) which is intended to engage a matching stacking step (9) in the other bin.

The neck (16) fitted into the top wall of the container is preferably positioned so as to clear the feet (14) of another container stacked on top.

The vertical stiffeners (17) provided in the walls of the stackable plastic bin of the type preferred, transfer vertical loads from the top rim (15) through the base step (9) and thence to the feet (14) of the base. Such loads are imposed when a filled container assembly is stacked upon another container assembly, such as in FIG. 2.

The other purpose of the vertical stiffeners (17) is to support the side walls of the pallet bin (1) against bulging due to the hydrostatic loads imposed on the side walls when the inner container (2) is filled. In general it will therefore be required that at least one such stiffener and preferably two or more, shall be provided for each such vertical flat sidewall. In the preferred embodiment, there are three such vertical stiffeners, the outer two on each flat face of the bin merge at the bin corners.

Optional positive retaining means may be provided to ensure that the inner container (2) is positively retained within the pallet bin (1). In this embodiment, the sample tap (7) penetrates the walls of both the pallet bin (1) and the inner container (2) and is to be rigidly clamped such that it acts to retain the container within the bin should the assembly be tipped over to empty out the contents (or for any other purpose). Many such retaining means shall be possible, such as cross bars fixed between two opposing walls of the bin bearing on or located above the container roof, compressible clamping of two opposing walls of a bin, or geometric overhanging features incorporated in the walls of the bin designed to interfere with the container after the outer bin is erected, to retain the container (2) within the bin (1).

Should it be desired to partially fill the container assembly, a flexible floating element, as described in WO 2005/052114 shaped to match the internal shape of the vessel, can be introduced prior to fitting the lid (3). This element will block most of the free surface area of the contained liquid. At any level of fill within the main body of the vessel, the use of this element enables the stored liquid to see approx. the same amount of oxygen per litre through that part of the walls in contact with the liquid, as well as that area in contact with the floating element.

In this embodiment, a pre-assembled pack of oak wood staves (not shown) may be introduced into the container before the lid is fitted and removed after the lid is removed.

The container of this invention can optionally be used to mature a wide range of different wines, spirits or other liquid foods, such as “Tabasco” or other foods or non-foods that may benefit from exposure over time to a controlled amount of oxygen.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification or in the references given is not, and should not be taken as an acknowledgment or any form of suggestion that such prior art forms part of the common general knowledge in Australia.

1. A container assembly for controlling the rate of oxygen transfer from the atmosphere into dry table wine stored within the container comprising,
a pallet bin with solid or erectable sides, a stacking feature and sufficiently strong and rigid walls or other load-bearing elements to allow at least one other full bin to be stacked upon it and an opening beneath it allowing entry for the tynes of a forklift,
a polyethylene container with a neck, allowing oxygen to enter at a rate between 5 mg/l./yr and 75 mg/l./yr, with a self-supporting shape that substantially conforms to the internal surface dimensions of the bin,
a removable closure for the neck having a recessed top face and a protruding, sealable outlet to allow filling to a level above the level of the recessed top face such that substantially all of the head space air in the container neck and under the closure can be discharged during filling,
a bottom outlet comprising a plug or a valve for draining liquid from the container assembly arranged on or near a bottom wall of the assembly.

2. The container assembly of claim 1 wherein the closure and neck comprise cooperating screw threads allowing the closure to be screwed onto the neck wherein the closure is large enough for a person to pass through.

3. The container assembly of claim 1 wherein the bottom outlet is located within a recess in the pallet bin, so that it is protected when the container assembly is being transported or stacked.

4. The container assembly of claim 2 wherein the bottom outlet is located within a recess in the pallet bin, so that it is protected when the container assembly is being transported or stacked.

5. A sealable closure for a container which enables the liquid level to be lowered when the lid is removed, comprising
a recessed face which is submerged when the container is full,
a protruding outlet extending above the recessed face,
a removable stopper to allow the discharge of head space air
a compliant ring seal or gasket which can engage between the closure and the top rim of the container to make a hermetic seal.

6. The sealable closure of claim 5 wherein the protruding outlet is located on and extends above the outer rim of the lid and allows substantially all of the head space air under the rim to be discharged on filling the container.

7. The sealable closure of claim 6 fitted with a flange that engages with a clamp ring and a mating flange on the container enabling sufficient clamping force to be exerted onto the seal ring to make a hermetic seal.

8. The container assembly of claim 1 combined with the closure described in claim 7.

9. The container assembly of claim 3 combined with the closure described in claim 7.

10. The container assembly of claim 4 further comprising a plurality of oak staves disposed in the interior of the container in contact with the wine

11. The container assembly of claim 8 further comprising a plurality of oak staves disposed in the interior of the container in contact with the wine

12. The container assembly of claim 9 further comprising a plurality of oak staves disposed in the interior of the container in contact with the liquid

13. A method of maturing dry table wine wherein wine is filled into the container described in claims 4 is stored therein for a period of not less than four months.

14. A method of maturing dry table wine wherein wine is filled into the container described in claims 10 is stored therein for a period of not less than four months.

15. A method of maturing dry table wine wherein wine is filled into the container described in claims 9 is stored therein for a period of not less than four months.

16. A method of maturing dry table wine wherein wine is filled into the container described in claims 12 is stored therein for a period of not less than four months.
